(19) United States
(12) Patent Application Publication
(10) Pub. No.: US 2006/0083136 A1
(43) Pub. Date: Apr. 20, 2006

(54) Disk recording and reproducing apparatus

(75) Inventor: Sang-hyun Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/248,184

(22) Filed: Oct. 13, 2005

(30) Foreign Application Priority Data
Oct. 14, 2004 (KR) 10-2004-0082032

(51) Int. Cl. G11B 7/00

(52) U.S. Cl. 369/47.52; 369/116

(57) ABSTRACT

A recording and reproducing apparatus using a laser diode generating beams at different wavelengths, the recording and reproducing apparatus including: a pickup having the laser diode, a photo diode to detect an optical output power of the laser diode, and a current variation unit to vary an output current of the photo diode according to the type of medium; and a pickup drive unit to select a current value conducting between an output terminal of the photo diode and an ground terminal by a recording medium selection signal based on the type of recording medium, and providing a driving current to drive the laser diode, the driving current being obtained based on the a difference between the selected current value and a predetermined current value.

### CROSS-REFERENCE TO RELATED APPLICATION

This application claims benefit under 35 U.S.C. § 119 from Korean Patent Application No. 10-2004-82032, filed on Oct. 14, 2004, the entire content of which is incorporated herein by reference.

### BACKGROUND OF THE INVENTION

1. Field of the Invention

The present invention relates in general to an (optical) disk recording and reproducing apparatus, and more specifically, to an (optical) disk recording and reproducing apparatus with a minimum construction and a minimum size of a control board controlling optical output of a laser diode installed in the apparatus.

2. Description of the Related Art

As a variety of optical disks are broadly used as storage media, a recent technical trend in optical pickup apparatuses is also to develop an apparatus capable of recording or reproducing information onto or from more than two optical disks in consideration of compatibility between optical disks. For examples, a DVD-ROM reproducing apparatus currently released in the market is capable of reproducing an existing CD, and a combo drive is now capable of reproducing and/or recording a CD, and reproducing a DVD. In the past, the optical disk recording and/or reproducing apparatus had a separate built-in laser diode corresponding to each recording medium (e.g., a CD or a DVD). But technical advances introduced a laser diode that can generate a plurality of wavelengths.

FIG. 1 is a block diagram of an ALPC (Automatic Laser Power Control) unit included in a conventional optical disk recording and reproducing apparatus. As can be seen in FIG. 1, the ALPC circuit includes a current controller 30 to select an output current of a photo diode 11a output from a pickup 10 by a recording medium selection signal; a first AMP 21 to compare a voltage across the selected current by the current controller 30 to a reference voltage (not shown); and a second AMP 22 to provide a current to a laser diode part 11 based on a result of the comparison of the first AMP. In this traditional ALPC circuit, a pick up drive unit 20 and the current controller 30 had to be mounted on one single board, system on chip (SoC), so the size of the board was usually large. Also, the board used at least 6 wires for connection with a pickup 10 showing a reciprocal (or to-and-fro) movement on the optical disk.

FIG. 2 illustrates an internal circuit diagram of the current controller 30 in FIG. 1.

In the current controller, one of variable resistances 12a and 12b provided to the pickup 10 by a transistor 31, turned on/off by a recording medium selection signal, forms a current path with a ground terminal.

Referring to FIG. 2, when the recording medium selection signal is logic “low”, the transistor 31 is turned off, and source voltage VCC passes through resistances 35 and 36 and is applied to a base terminal of the transistor 37. Then, the transistor 37 is turned on, and a current path having a predetermined resistance (a resultant resistance of resistance 38 and an internal resistance of the transistor 37) is formed between a terminal DVD_VR and the ground terminal. Here, the collector terminal of the transistor 32 enters a high-impedance state. In contrast, when the recording medium selection signal is logic “high”, the transistor 37 is turned on and source voltage VCC is discharged to the ground terminal, so that the transistor 37 is turned off. At this time, the transistor 32 is turned on, and conducts a terminal CD_VR and a ground terminal. That is, in the pickup drive unit 20, a current applied to the first AMP 21, in response to the recording medium selection signal, varies, and the first AMP 21 controls an optical power output of the laser diode 11 based on the comparison of a reference voltage to a voltage corresponding to the applied current. In the case of the traditional ALPC circuit, the current controller composed of at least three transistors and six resistances and the pickup drive unit were arranged on the same circuit board, and connected to the pickup 10 moving to and fro to read and/or write an optical disk through at least 6 wires. This not only increased the size of the board, but also caused wire separation and contact failure. In addition, a processor (not shown) provided to control the optical disk recording and/or reproducing apparatus must allocate a separate port to apply the recording medium selection signal to the current controller 30. In so doing, the processor is often deprived of its operable input/output ports to the current controller 30.

### SUMMARY OF THE INVENTION

It is, therefore, an aspect of the present invention to provide an optical disk recording and reproducing apparatus having a minimal construction and a minimal size of an ALPC circuit, using a least number of input/output ports of a processor.

Another aspect of the present invention is to provide an optical disk recording and reproducing apparatus using a minimum number of wires for connecting a pickup and a board installed therein, thereby increasing durability of the apparatus.

To achieve the above and/or other aspects and advantages, embodiments of the present invention include an optical disk recording and/or reproducing apparatus for recording/reproducing information onto/from an optical disk by laser beams at different wavelengths scanned from a laser diode, which the apparatus includes: a pickup including the laser diode, a photo diode to detect an output power of the laser diode, and a current variation unit to vary an output current of the photo diode according to a type of medium, e.g., a type of optical disk; and a pickup drive unit to select a current value conducting between an output terminal of the photo diode and a ground terminal by a recording medium selection signal based on the type of recording medium of the optical disk, and providing a driving current to drive the laser diode, the driving current being obtained on the basis of a difference between the selected current value and a predetermined current value.

According to an embodiment of the present invention, the pickup drive unit may include: a current controller to generate a current value corresponding to one of a plurality of output currents from the current variation unit by the recording medium selection signal; a first AMP to compare a current value output from the current controller by the recording medium selection signal to a predetermined current value, and calculating a difference thereof; and a second AMP to generate a driving current to drive the laser diode based on the difference obtained by the first AMP, and providing the driving current to the laser diode. The output value of the first AMP may further be an analog voltage value.

Also, the current controller may include: a switching unit to select one of the plurality of currents output from the current variation unit by the recording medium selection signal; and a current variation unit to form a current path between output currents from the current variation unit and the ground terminal, respectively, wherein each current path has a predetermined resistance value.

Also, the current variation unit may include a plurality of resistances arrayed between the plurality of currents output from the current variation unit by the recording medium selection signal and the ground terminal.

According to an embodiment of the present invention, the first AMP may include: a reference voltage generator to generate a reference voltage corresponding to the selected recording medium by the recording medium selection signal; and a comparer to compare an output value from the reference voltage generator to the output value from the current controller.

Also, the reference voltage generator may divide a predetermined reference voltage in response to the recording medium selection signal.

Also, the pickup drive unit may be disposed on one side of a frame forming the optical disk recording and/or reproducing apparatus, and may not require a separate print circuit board.

To achieve the above and/or other aspects and advantages, embodiments of the present invention include a method of recording/reproducing information to/from a medium using a laser diode generating light beams of different wavelengths, the method including detecting an optical output power of the laser diode through a photo diode, varying an output current of the photo diode based on a medium type of the medium, selecting a current value conducting between an output terminal of the photo diode and a ground terminal according to a recording medium selection signal, based on the medium type of the medium, and providing a driving current to drive the laser diode, the driving current being obtained based on a difference between the selected current value and a predetermined current value.

The method may further include generating the current value as corresponding to one of a plurality of output currents from a current variation unit according to the recording medium selection signal, comparing an output current value output from a current controller, according to the recording medium selection signal, to a predetermined current value, generating the driving current to drive the laser diode based on a calculated difference between the output current value and the predetermined current value.

To achieve the above and/or other aspects and advantages, embodiments of the present invention include a recording and/or reproducing apparatus for recording/reproducing information to/from a medium using a laser diode generating light beams of different wavelengths, the apparatus including a pickup means for detecting an optical output power of the laser diode through a photo diode, a varying means for varying an output current of the photo diode based on a medium type of the medium, a selecting means for selecting a current value conducting between an output terminal of the photo diode and a ground terminal according to a recording medium selection signal, based on the medium type of the medium, and a driving means for providing a driving current to drive the laser diode, the driving current being obtained based on a difference between the selected current value and a predetermined current value.

The apparatus may further include a current controller means for generating the current value as corresponding to one of a plurality of output currents from a current variation unit according to the recording medium selection signal, a first amplifier means for comparing an output current value output from a current controller, according to the recording medium selection signal, to a predetermined current value, a second amplifier means for generating the driving current to drive the laser diode based on a calculated difference between the output current value and the predetermined current value.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual block diagram of an ALPC (Automatic Laser Power Control) unit in a conventional optical disk recording and/or reproducing apparatus;

FIG. 2 illustrates an internal circuit diagram of the current controller in FIG. 1;

FIG. 3 is a block diagram of an ALPC circuit built in an optical disk recording and/or reproducing apparatus, according to an embodiment of the present invention;

FIG. 4 is a detailed block diagram of a first AMP, such as the first AMP in FIG. 3, according to an embodiment of the present invention; and

FIG. 5 illustrates a wire connection between a pickup and a pickup drive unit in an optical disk recording and/or reproducing apparatus with an ALPC circuit, according to an embodiment of the present invention.

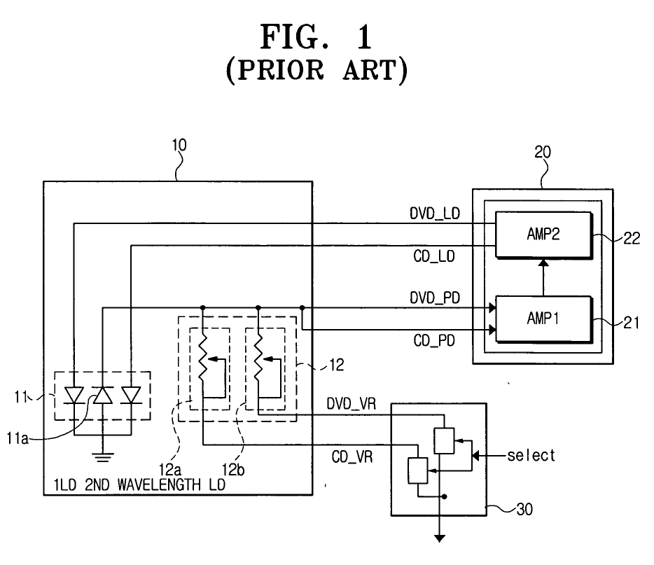

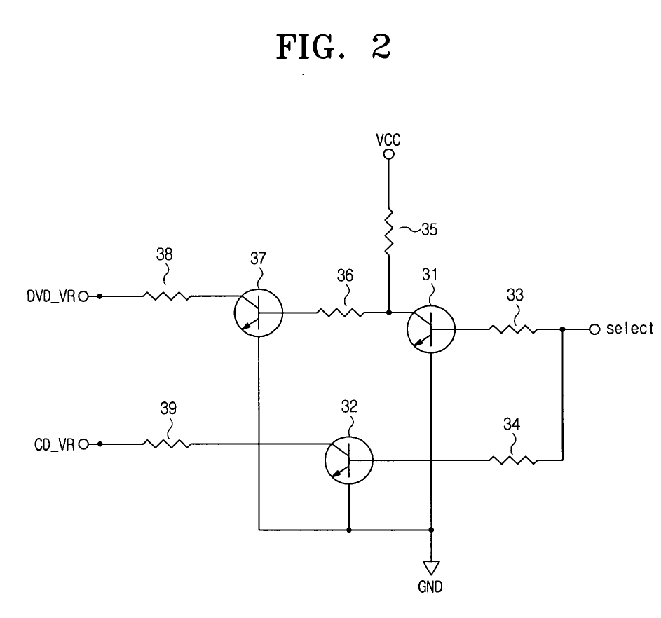

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

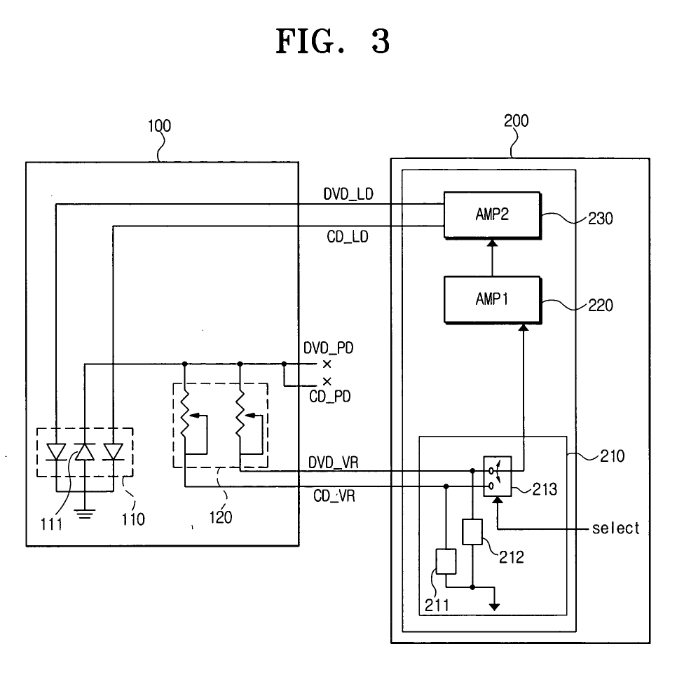

FIG. 3 is a block diagram of an ALPC circuit built in an optical disk recording and/or reproducing apparatus, according to an aspect of the present invention.

As shown in FIG. 3, the ALPC circuit may include a pickup unit 100, and a pickup drive unit 200 which increases or decreases current flow applied to a laser diode unit 110 of the pickup unit 100, according to an output current thereof, and thus, control the output of the laser diode unit 110. The pickup unit 100 may include a laser diode unit 110 having a variable wavelength according to a kind of an optical disk such as a CD and a DVD; a photo diode 111 in the laser diode unit 110, to detect an output of the laser diode 110; and a current variation unit 120 connected to input/output ports DVD_VR and CD_VR provided by the pickup drive unit 200, to vary an output current of the photo diode 111.

The pickup drive unit 200 may include a current controller 210 to form a current path between one of input/output ports DVD_VR and CD_VR provided to the pickup unit 100 and the ground terminal by a medium selection signal; a first AMP 220 to compare a voltage across the output value of the current controller 210 with a reference voltage, and to calculate a difference thereof; and a second AMP 230 to generate a driving current to drive the laser diode 110 based on the difference, and to provide the current to a laser diode 110.

Here, the recording medium selection signal may be generated by a micro controller (not shown) built in the optical disk recording and/or reproducing apparatus, and provided to the pickup drive unit 200. Based on the type of medium, i.e., the “type” corresponding to whether the medium meets certain different medium specifications (e.g., a CD specification or a DVD specification), inserted into the optical disk recording and/or reproducing apparatus, the recording medium selection signal is logic “high” or logic “low”.

In response to the recording medium selection signal, the current controller 210 can form a current path between one of the input/output ports DVD_VR and CD_VR, provided to the current variation unit 120, and the ground terminal. Resistances 211 and 212 of the current controller 210 may have predetermined values. Although FIG. 3 shows only two resistances 211 and 212 conducting between the input/output ports DVD_VR and CD_VR and the current controller 210, more resistances may be added, and the additional resistances can be applied to the first AMP 220 by the medium selection signal. In such case, the recording medium selection signal may be formed of at least 2 bits. For instance, the recording medium selection signal may be “00”, “01”, “10” and “11” or “000”, “001”, “010”, “011”, “100”, “101”, “110” and “111”, and enable the current controller 210 to form diverse routes for the current flow between the input/output ports DVD_VR and CD_VR and the ground terminal. When the recording medium selection signal is formed of at least 2 bits, a plurality of built-in resistances (at least two) in an array may further be used, so that the pickup drive unit 200 can selectively use any desired resistance.

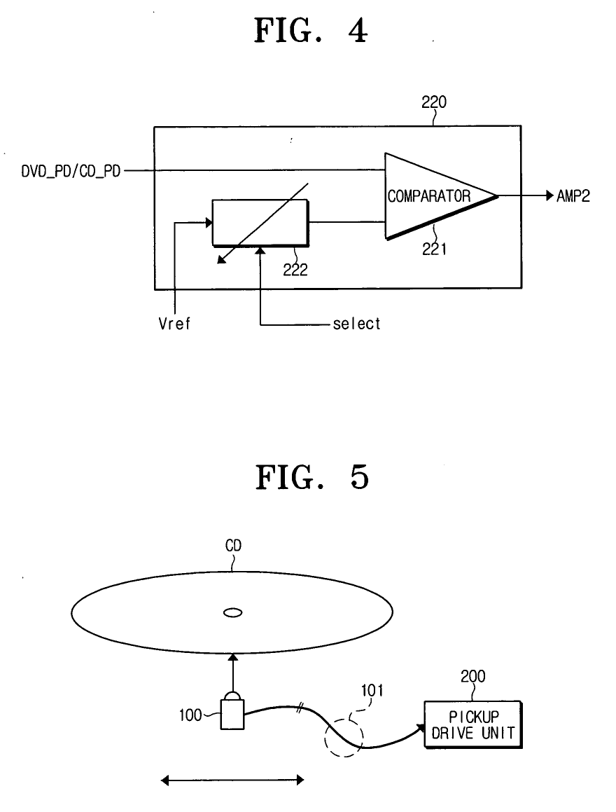

The first AMP 220 may receive an output current from the current controller 210 and obtain a voltage value for the current of the first AMP 220. Then, the first AMP 220 can compare the voltage value with a reference voltage that is generated by dividing a predetermined voltage with the recording medium selection signal. This operation will be explained in greater detail in reference to FIG. 4. FIG. 4 is a detailed block diagram of a first AMP, such as the first AMP in FIG. 3, according to an embodiment of the present invention.

As shown in FIG. 4, the first AMP 220 may include a comparator 221 to compare a voltage value DVD_PD, CD_PD (i.e., a main input) for an output current from the current controller 210 with an output voltage (i.e., a sub input) from a reference voltage generator 222 (to be further described below); and a reference voltage generator 222 to divide a predetermined voltage Vref by the recording medium selection signal, and generate a reference voltage by the type of optical disk inserted into the optical disk recording and/or reproducing apparatus. Since optical outputs and wavelengths of the laser diode 110 differ depending on the type of recording medium used in the optical disk recording and/or reproducing apparatus, the reference voltage generator 222 may generate different reference voltages depending on recording medium inserted into the optical disk recording and/or reproducing apparatus. Here, since the reference voltages for different types of media may differ according to individual vender specifications for their respective recording and/or reproducing apparatuses, it will not be necessary to discuss specific values of the reference voltages herein. An output from the first AMP 220 may have an analog voltage value, and this value can equal a difference between the applied voltage DVD_PD, CD_PD, to the comparator 221, and a reference voltage applied from the reference voltage generator 222, to the comparator 221. The second AMP 230 may decide an output value of the laser diode 110 based on the output value of the first AMP 220, and either increase or decrease an applied current value to the laser diode 110 according to a result of the decision. If an output value of the first AMP 220 has a positive value, for example, it may mean that the applied voltage value DVD_PD, CD_PD to the first AMP 220 is greater than the reference voltage applied from the reference voltage generator 222 to the comparator 221. In this case, the second AMP 230 may decrease the applied current to the laser diode 110, and if the value is not positive, the second AMP 230 may increase the applied current to the laser diode 110.

FIG. 5 illustrates a wire connection between the pickup 100 and the pickup drive unit 200 in an optical disk recording and reproducing apparatus to which the ALPC circuit of the present invention may be applied.

Referring to FIG. 5, the pickup 100 and the pickup drive unit 200 can be connected through four strands of wire 101. As illustrated, the pickup 100 may move from side to side of the optical disk, and the wire 101 connected to the pickup 100 can repeatedly expand and contract (i.e., stretch) along with the movement of the pickup 100. Since four strands of wire 101, rather than six strands of wire as in the conventional systems, are used, the occurrence of metal fatigue to the wire during the stretching is greatly reduced, with the lifespan of the wire correspondingly being increased. Moreover, although the conventional optical disk recording and reproducing apparatus required a separate board for the installation of the pickup drive unit and the current controller, the system-on-chip of the present invention can be installed on the optical disk recording and reproducing apparatus without using a separate board. This is made possible by integrating the current controller 210 into the system-on-chip, and reducing the number of strands of wire connected to the pickup 100. As a result, not only has the size of the optical disk recording and reproducing apparatus been reduced, but the cost of manufacture thereof has also been markedly reduced.

As explained above, according to embodiments of the present invention, the size of the ALPC circuit board provided to the optical disk recording and reproducing apparatus can be minimized, and in some cases, it is also possible to attach the system-on-chip of the ALPC circuit to a frame for the optical disk recording and reproducing apparatus. In either case, the size of the optical disk recording and reproducing apparatus can be minimized.

Furthermore, by integrating the current controller of the ALPC circuit into the system-on-chip and by providing the current controller with the recording medium selection signal based on the type of medium inserted into the optical disk recording and reproducing apparatus, it becomes possible to minimize the usage count of the input/output ports of the processor installed in the optical disk recording and reproducing apparatus.

Also, by minimizing the number of strands of wire connected between the pickup and the pickup drive unit, damage to the wire (e.g., metal fatigue), due to the repetitive stretching of the pickup, can be minimized.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A recording and/or reproducing apparatus for recording/reproducing information to/from a medium using a laser diode generating light beams of different wavelengths, the apparatus comprising:
a pickup part comprising the laser diode, a photo diode to detect an optical output power of the laser diode, and a current variation unit to vary an output current of the photo diode based on a medium type of the medium; and
a pickup drive unit to select a current value conducting between an output terminal of the photo diode and a ground terminal according to a recording medium selection signal, based on the medium type of the medium, and to provide a driving current to drive the laser diode, the driving current being obtained based on a difference between the selected current value and a predetermined current value.

2. The apparatus of claim 1, wherein the pickup drive unit comprises:
a current controller to generate a current value corresponding to one of a plurality of output currents from the current variation unit according to the recording medium selection signal;
a first amplifier (AMP) to compare a current value output from the current controller, according to the recording medium selection signal, to a predetermined current value, and to calculate a difference between the current value and the predetermined current value; and
a second amplifier (AMP) to generate a driving current to drive the laser diode based on the difference obtained by the first AMP, and to provide the driving current to the laser diode.

3. The apparatus of claim 2, wherein the output value of the first AMP is an analog voltage value.

4. The apparatus of claim 2, wherein the current controller comprises:
a switching unit to select one of the plurality of currents output from the current variation unit according to the recording medium selection signal; and
a current variation unit to form a current path between output currents from the current variation unit and the ground terminal, wherein each current path has a predetermined resistance value.

5. The apparatus of claim 4, wherein the current variation unit comprises a plurality of resistances arrayed between the plurality of currents output from the current variation unit, according to the recording medium selection signal and, the ground terminal.

6. The apparatus of claim 2, wherein the first AMP comprises:
a reference voltage generator to generate a reference voltage corresponding to the recording medium selection signal; and
a comparer to compare an output value from the reference voltage generator to the output value from the current controller.

7. The apparatus of claim 6, wherein the reference voltage generator divides a predetermined reference voltage in response to the recording medium selection signal.

8. The apparatus of claim 1, wherein the pickup drive unit is disposed on one side of a frame forming the recording and reproducing apparatus, and does not require a separate print circuit board.

9. The apparatus of claim 1, wherein the pickup drive unit is disposed on a system-on-chip.

10. The apparatus of claim 1, wherein the medium type is any one of DVD (Digital versatile Disk) medium type or CD (Compact Disk) medium type.

11. The apparatus of claim 1, wherein the recording medium selection signal comprises at least 2 bits.

12. A method of recording/reproducing information to/from a medium using a laser diode generating light beams of different wavelengths, the method comprising:
detecting an optical output power of the laser diode through a photo diode;
varying an output current of the photo diode based on a medium type of the medium;
selecting a current value conducting between an output terminal of the photo diode and a ground terminal according to a recording medium selection signal, based on the medium type of the medium; and
providing a driving current to drive the laser diode, the driving current being obtained based on a difference between the selected current value and a predetermined current value.

13. The method of claim 12, further comprising:
generating the current value as corresponding to one of a plurality of output currents from a current variation unit according to the recording medium selection signal;
comparing an output current value output from a current controller, according to the recording medium selection signal, to a predetermined current value;
generating the driving current to drive the laser diode based on a calculated difference between the output current value and the predetermined current value.

14. A recording and/or reproducing apparatus for recording/reproducing information to/from a medium using a laser diode generating light beams of different wavelengths, the apparatus comprising:
a pickup means for detecting an optical output power of the laser diode through a photo diode;
a varying means for varying an output current of the photo diode based on a medium type of the medium;
a selecting means for selecting a current value conducting between an output terminal of the photo diode and a ground terminal according to a recording medium selection signal, based on the medium type of the medium; and
a driving means for providing a driving current to drive the laser diode, the driving current being obtained based on a difference between the selected current value and a predetermined current value.

15. The apparatus of claim 14, further comprising:
a current controller means for generating the current value as corresponding to one of a plurality of output currents from a current variation unit according to the recording medium selection signal;
a first amplifier means for comparing an output current value output from a current controller, according to the recording medium selection signal, to a predetermined current value;
a second amplifier means for generating the driving current to drive the laser diode based on a calculated difference between the output current value and the predetermined current value.
